(19) United States
(12) Patent Application Publication
(10) Pub. No.: US 2008/0292505 A1
(43) Pub. Date: Nov. 27, 2008

(54) Disposable safety pipet

(76) Inventor: Jiamin Tian, Bronx, NY (US)

Correspondence Address: Allan Chan & Associates, Suite 700, 225 Broadway, New York, NY, 10007, US

(21) Appl. No.: 12/154,904

(22) Filed: May 27, 2008

Related U.S. Application Data
(60) Provisional application No. 60/931,864, filed on May 25, 2007.

(51) Int. Cl. B01L 3/02

(52) U.S. Cl. 422/100

(57) ABSTRACT

A disposable safety pasteur pipet having an integral elongated stem 1 and tubular body 5 with a end 10 and produced from a polymer such as nontoxic polyethylene. The elongated stem 1 ensures that the fluid flows from the stem 1 to the body 5; thus preventing any reverse flow resulting in contamination. The polymer composition of the pipet precludes the fragileness of glass pipets; as well as injuries associated with shattering glass. The primary use of said invention is to be an aspirating pipet attached to a vacuum hose. The current invention would be substantially in similar dimensions to traditional glass Pasteur pipets.

### CLAIM OF PRIORITY

This patent application claims priority from provisional patent application, Ser. No. 60/931,864, filed on May 25, 2007.

### BACKGROUND

Pipettes are well-known devices which are designed to dispense measured quantities of liquids, particularly in uniform drops of a given volume. Pipettes have had widespread usage in a number of industries where accurate measurement and delivery of fluids are required, particularly the medical and laboratory testing and analysis fields.

Numerous types of pipettes have been proposed and developed throughout the years. Most rely on a construction which includes a narrow tube or stem 1 into which the liquid is drawn. A flexible bulb, usually made from rubber or a similar flexible material, is connected to the stem 1 to produce a vacuum when the bulb is squeezed to draw the liquid into the stem 1. Once fluid is drawn into the stem 1, it will remain there until the bulb is again squeezed by the user to release some or all of the fluid. By carefully manipulating the bulb, a user can generally release the fluid a drop at a time. The size or volume of the drop is usually determined by the size of the opening formed at the tip of the stem 1. The stem 1 may also include calibrations which allow the user to deliver larger measured amounts of liquid at one time.

Early style pipettes were generally made from glass tubing and a flexible rubber bulb attached at one end 10 of the tubing. Advances in plastic forming techniques have resulted in the development of disposable plastic transfer pipettes which prove to be somewhat reliable and eliminate a number of the disadvantages associated with glass pipettes. For example, glass pipettes are susceptible to breakage during transportation from the manufacturer and also during usage which can prove to be detrimental from a cost standpoint. Additionally, there is a potential for contamination in glass pipettes especially if the rubber bulb is interchanged on a number of glass tubings. Also, if the glass tubing is broken, the user is subjected to possible infection or contamination if cut by the broken glass.

### SUMMARY OF THE INVENTION

A disposable safety pasteur pipet having an integral elongated stem 1 and tubular body 5 with a tapered end 10 and produced from a polymer such as nontoxic polyethylene. The elongated stem 1 ensures that the fluid flows from the stem 1 to the body 5; thus preventing any reverse flow resulting in contamination. The polymer composition of the pipet precludes the fragileness of glass pipets; as well as injuries associated with shattering glass. The primary use of said invention is to be an aspirating pipet attached to a vacuum hose. The current invention would be substantially in similar dimensions to traditional glass Pasteur pipets.

In biomedical research, such as in vitro cell culture technique, removing spent media or other solutions from tissue culture vessels or centrifuge tubes is a very common maneuver for utilizing a safer Pasteur pipet. This is mostly accomplished by attaching a pipet with a vacuum line or vacuum bulb to the end 10 of the pipet. Said tapered end 10 would allow easier insertion of the hose onto the pipet. The pipet is then put into the vessel or tube to suck out the liquid. A longer elongated stem 1 can make sure that the fluid flows from the stem 1 to the body 5 then into the rubber tube. Any tiny reverse flow would result in the cell contamination. Therefore, lots of researchers still use Glass Pasteur pipet regardless its disadvantages. The current invention includes many advantages such as but not limited to:
This shatterproof pipet can eliminate the hazards of broken glass and loss of valuable fluid or cells it may carry, and possible contamination to the environment or people, because the fluid or cells can be toxic or infectious.
It can be easily and safely discarded as regular biohazard waste. There is no need for the special “sharp container”.

The flexible stem 1 can be bent to draw liquids from, or put liquid into, narrow, small or irregular-shaped containers.

It eliminates the need of foam pad in the packages of glass Pasteur pipet to preserve tip 12.
It can be easily sealed.
It can be used in liquid nitrogen.
It can be gas sterilized.
It delivers repeatable drop size.
Its low-affinity, nontoxic and inert surface reduces loss of cells and valuable proteins due to binding.
In addition to the size of traditional glass Pasteur pipet (Overall length 14.6 cm with body 5 6 of 8.9 cm and stem 1 10 of 5.7 cm, or overall length 22.9 cm with body 5 6 of 10.2 cm and stem 1 10 of 12.7 cm, with top 2 O.D. of 7 mm and tip 12 O.D. of 1.5 mm), it can be made of different size to suit different tasks. The length of body 5 6 and stem 1 10, and the diameter of top 2 and tip 12 can be different.
It can be made with or without constriction 4 and supplied with or without plugs.
It can be put into different packages, such as individually peel-apart sleeves, or bulk-packaged in easy-open bags or containers which can be served as dispensers for easy access.

### BRIEF DESCRIPTION OF THE DRAWINGS

FIG. 1 is a side elevational view of a plastic pipette having an elongated stem 1 and a straight end 10.

FIG. 2 is a side elevational view of a plastic pipette having a varied elongated stem 1 and a straight end 10.

FIG. 3 is a side elevational view of a plastic pipette having a short stem 1 and a straight end 10.

FIG. 4 is a side elevational view of a plastic pipette having an elongated stem 1 and a tapered end 10.

FIG. 5 is a side elevational view of a plastic pipette having an elongated stem 1 and a rounded end 10.

FIG. 6 is a side elevational view of a plastic pipette having an elongated stem 1 and a straight end 10.

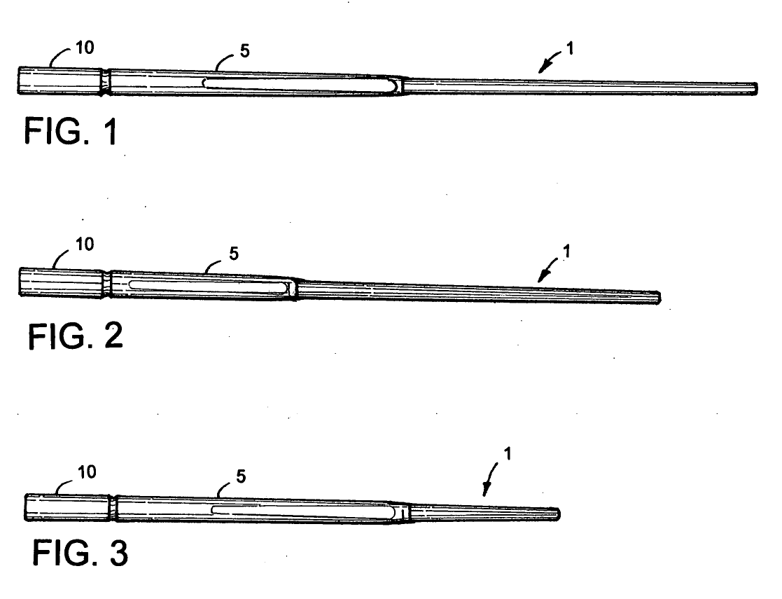

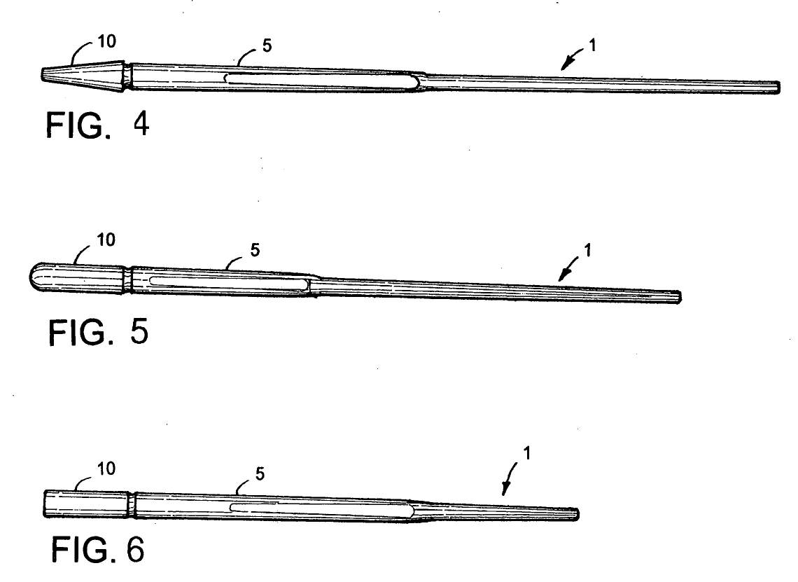

### DESCRIPTION OF THE PREFERRED EMBODIMENT

The pipet comprises a tubular body 5 having an open upper tapered end 10 and an elongated tapered stem 1. Alternatively, the tapered end 10 may be made from a rigid material, such as plastic or metal, and may include a cylindrical socket and resilient packing or sealing means, such as an O-ring, disposed within a circumferential groove formed within the cylindrical socket.

The pipet may be made from a flexible, semi-flexible, semi-rigid, rigid or deformable material, such as but not limited to non-toxic polymers, nontoxic polyethylene, plastic tubing, non-toxic rubber. It is not essential that the pipet have precise internal dimensions or volumetric indicia on its outer surface. The pipet may be transparent or opaque. Nevertheless, in an alternative embodiment, said pipet may having volumetric indicators along the body 5.

To prevent contamination the stem 1 of the pipet is an elongated and tapered. In an alternative embodiment, to further assure that the fluid to be pipetted does not contaminate the pipetting apparatus, may have a filter mechanism, such as a sterile cotton wad, enlodged in the upper end 10 of the pipet.

The vacuum source or fluid suction generating mechanism used with the present invention may be but not limited to: a rubber bulb, conventional vacuum pump, water actuated vacuum, or electric pump which preferably continuously supplies fluid suction to said pipet.

In an alternative embodiment, said pipet may exhibit a color change once utilized or if its opened from its packing to prevent contamination. In one embodiment, the pipet comprises a modified thermoplastic resin with built-in sensitivity to a color change activator (e.g., light, oxygen, and/or the like). In the case of resin used for medical devices, the resin could have a built-in sensitivity to color change activators such as light, oxygen, chemicals from rinsing/cleaning solutions (e.g. acid, base sensitivity), sterilization chemicals (e.g., hydrogen peroxide, ethylene oxide, and the like), body 5 fluids (e.g., blood, plasma, and the like), special sterilization processes (such as gamma radiation sterilization, electron beam sterilization, and the like), and the like, as well as combinations comprising at least one of the foregoing sensitivities. Upon exposure to a color change activator (e.g., removing from the packaging, tampering, using, reprocessing, and so forth), the active leuco dye, for example, easily converts to its oxidized form (for instance by an oxidation process involving the presence of oxygen), thereby absorbing light at a higher wavelength than the leuco form. This absorption is generally located in the visible part of the electromagnetic spectrum thus leading to the formation of a visible color.

In pipet, the built-in sensitivity could be visually detectable (for example an appearance or visible color change in the pipet), or may use a detector (e.g., an excitation source). In one embodiment, the pipets can be produced directly in a sensitive form immediately after injection-molding or extrusion (e.g., the article is oxygen sensitive immediately after molding and significant exposure to oxygen/air would result in a visible color change). For example, a significant color change from an original color would correspond to a CIELAB .DELTA.E* value of greater than or equal to about 5 units, or, more specifically, greater than or equal to about 10 units, and more specifically, greater than or equal to about 20 units. The affect of exposure of the color changing specie to the color change activator can be controlled to attain a color change in a desired period of time. For example, a CIELAB .DELTA.E* of greater than or equal to 5 units, or, more specifically, greater than or equal to about 10 units, in a desired period. If an essentially immediate color change is desired, a change can occur in less than a few minutes. If a slow color change is desired, a change can occur after several hours. For example, for a surgical instrument, a significant color change could occur after a desired period of greater than or equal to about 8 hours, or, more specifically, greater than or equal to about 12 hours, or, even more specifically, greater than or equal to about 24 hours, after initial exposure to the color change activator, wherein, in less than the desired period, the CIELAB .DELTA.E* is less than or equal to 4 units, or, more specifically, less than or equal to 3 units. Unless otherwise specified, CIELAB .DELTA.E* value is determined using a sphere instrument (10 nanometer (nm) resolution color spectrophotometer; e.g., Gretag MacBeth 7000A) and the instrument settings are: UV included, SCI, D65 illuminant and 10 degree observer). Additionally, unless otherwise specified, transparent and slightly translucent samples (ASTM D1003 percent haze (% haze) .ltoreq.10) will be measured in transmission mode, whereas heavily translucent samples (% haze .gtoreq.10) and opaque samples will be measured in reflectance mode with white tile backing. Spectrophotometric data are collected in accordance with ASTM methods E1164 and CIELAB values are calculated by the spectrophotometer software in accordance with ASTM E308.)

In another embodiment, the pipets can be produced in a non-activated form (blocked) that can later be activated by a secondary operation (e.g., a post-processing) such as exposure to light (e.g., UV photoflash), heat (e.g., heat pulse), cleaning and/or sterilization processes (e.g., autoclaving, gamma radiation sterilization, ethylene oxide sterilization, electron beam radiation sterilization, enzymatic cleaning, disinfecting solution, and the like), and the like, as well as combinations comprising at least one of the foregoing secondary operation (wherein the light, heat, sterilizers, cleaners, etc., are “deblockers”). For example, pipet can be handled similar to those formed from standard thermoplastic resin until they are activated with the secondary operation. UV exposure can be used during adhesive curing operations used to bond parts during medical device assembly (e.g., a stopcock valve on a trocar). During the curing operation, the trocar is exposed to UV light that can cause deblocking (e.g., activation) of the color changing specie. In other words, a blocked color changing specie can be used initially blocked for facile processing and manufacturing. During (or after) the manufacturing process (e.g., before or after packaging), the blocked color changing specie can be activated such that it will change color after exposure to the color change activator. If deblocking is intend 10ed to occur after the manufacturing process, the deblocking mechanism for the blocked color changing specie should be different than processing employed during manufacturing.

The chemistry of the color changing specie can be selected such that the color changing process is initially delayed to allow for handling and packaging operations to proceed. An example of this process would be the use of a color changing specie having hydrolysable blocking group, the use of groups that are photosensitive to ambient light, and the like, as well as combinations comprising at least one of the foregoing. Some possible blocking groups include a carbamate, thiocarbamate, enamine, imine, acetal, sulfenyl, sulfonyl, phosphoryl, alkyl, imide, amide, benzylic moiety, peptide moiety, protein moiety, and the like, as well as combinations comprising at least one of the foregoing blocking groups. In yet a further embodiment, the color change can be from a low chroma color (e.g., white, gray, and so forth) to a higher chroma color (e.g., blue, green, and so forth). Optionally, the color change specie can be chemically bound (e.g., covalently bonded) to the resin.

For example, a pipethaving the built-in sensitivity (either as a whole or in some component(s) of the article) can be medical devices used in surgical operations, such as a trocar, a harmonic scalpel, a stapler, and the like. The color change can be initiated upon opening a sealed package containing the article. Alternatively, the article can have a built-in usage/exposure indicator. For example, the article can be a trocar having a housing and/or obturator (or cap) that connects onto the housing, wherein the housing is molded from the resin with the color changing specie.

The color change can be a general color change of the entire surface of the article, or the color change can provide a specific pattern or text message. For example, the color change can result in elimination of the name of the original manufacturer and/or other text. To achieve such a result, the color change must result in a decrease in contrast between the printed information on the article and the remainder of the article. A color change may indicate that an article: (i) has been removed from its original package, (ii) has been used, (iii) has been tampered with, (iv) has been reprocessed, (v) is no longer covered by the manufacturer warranty, and so forth, as well as combinations comprising at least one of the foregoing. For example, the article is a stapler or a harmonic scalpel. The color changing specie can be a component of the material used to make all or a portion of the article (e.g., the handle, the housing, and/or the trigger of the article) such that a color change occurs after the device is removed from its original package, used, or reprocessed. Note that the portion of the article that contains the color changing specie can be opaque or transparent. The selection of an opaque or transparent matrix will be based on functional requirements (e.g. transparency needed to see through the part, or opaque glass filled material needed to have a high modulus, add strength and/or reduce the thermal expansion coefficient of the material), as well as aesthetic requirements for the device.

The built-in sensitivity can be a color/appearance change (hereinafter color change), wherein the color/appearance change can be such that: (i) a lightness of the pipet will drop by greater than or equal to about 10 units when measured in transmission or reflectance mode using a D65 source and a 2-degree illuminant; (ii) a total light transmission through the pipet wall, measured according to ASTM D1003, decreases by greater than or equal to about 10%; (iii) (for transparent pipets and devices) the lightness or light transmission changes can be such that the visibility through the pipet reduces so as to affect functionality (for instance: one cannot clearly see: what is inside the pipet, a liquid/filling level, printings on the pipet, device features are no longer visible, and/or the like); and the like, as well as combinations comprising at least one of the foregoing changes. For example, the equipment can originally be clear (e.g., almost colorless), have a light color (e.g., amber), or the like, after molding. After use (e.g., tampering or otherwise exposure to the color change activator, the color (in an area or of the entire equipment) can switch to a dark (e.g., almost black) color.

For example, the resin used to produce the equipment can change color as a result of a marking process induced by light (e.g., Xenon lamp exposure, UV lamp exposure, UV or visible diode laser exposure, and the like, as well as combinations comprising at least one of the foregoing). This color change can be throughout the equipment, or in an area (e.g., spots, text, alphanumerical characters; e.g., an inscription such as “do not reuse” or “device used by XYZ”, “used”, “contaminated” “obsolete”, “opened”, a date, and the like, as well as combinations comprising at least one of the foregoing). The marking (e.g., color change) can be automatic or can be initiated; e.g., by a medical professional (e.g., surgeon, physician, nurse, and the like). For example, the medical professional can “mark” the item by triggering an irreversible local or total color change of the pipet by exposing it to a particular light source. This marking can be used to “obsolete” the part (e.g., for instance turning a clear part into a dark part). During a future medical procedure, a medical professional will inspect pipet and readily know if it has been previously made “obsolete” (by checking if the pipet has undergone a color change) and validate the use based on the result of the inspection.

Example of color changing species includes organic color matter (e.g., organic molecules) that undergo a color change following an oxidation process. In one embodiment, the color changing species will be added to a resin during the formation of the article. Optionally, the color changing species can be materials having enough heat stability to be processed with the plastic material such that the plastic pellets used to form the pipetwill have built-in color changing capability. The color changing specie can be present in a separate layer (e.g., film) that is applied to the device (e.g., by an IMD (in-mold decoration) process). In such case, the additive can be dispersed in the film material, and/or applied by a coating process, screen printing process, or the like, on top of the film. Such process may be useful when the color changing specie has a heat or processing stability that is not sufficient to be compatible with the extrusion/injection molding process used to produce the device. The color changing species can be in a non-ionic form, e.g., that can be transformed into an ionic form of a different color, e.g., upon exposure to a color change activator. The color changing specie can be in a form that is not oxygen sensitive. In a further embodiment, the color changing specie can be in a non-ionic form that is a blocked reduced form of a colorant. Essentially, the color changing specie can be in a stable form while being handled. The stable state can be a permanent state (e.g., no specific shelf life for the additive) or could be limited to a certain period of time (e.g. core-shell encapsulated activated additives). Organic color changing species can in a leuco form that has been made stable by blocking and/or encapsulation thus allowing the color changing specie to be handled in the presence of the color change activator during the manufacturing process. The blocking group can maintain the molecule in a blocked leuco form (i.e., in a state where the electronic conjugation in the chromophore is interrupted). After an activation/deblocking step, the leuco form becomes sensitive to the color change activator (the electronic conjugation is no longer interrupted) resulting in a visible color change after exposure to the color change activator.

Color changing species can include dyes, dyestuff, charge-transfer complexes, absorbers, colorants, pigments, complexes, and the like, hereinafter collectively “coloring matter”, wherein dyes can be advantageous since they disperse into a resin matrix without adding haze to the material, and therefore the dye can be used for both transparent and opaque applications. Possible color changing species include leuco coloring matter, such as the leuco form of the azine coloring matter family (e.g., thiazine, oxazine, phenazine, phenoxazines, phenothiazines and the like), leuco aryl methane coloring matter, leuco indigo coloring matter, and the like, as well as derivatives and combinations comprising at least one of the foregoing color changing species, with dyes of these color changing species advantageous. Some examples of such coloring matter include the leuco form of methylene blue and basic blue 3. Formula I represents a generic structure for the leuco form of a blocked azine dye (i.e., an inactive material) (X.dbd.N for phenazine; X.dbd.O for phenoxazines, and X.dbd.S for phenothiazines). Formula I sets forth a generic structure of a blocked azine leuco dye: In Formula I, X in Formula I can be O or S. R.sub.1 to R.sub.8, individually, represent a halogen atom, a hydroxy group, an amino group, an alkyl group, an alkylamino group, a dialkylamino group, an alkyl ether group, a cycloalkyl group, a cyclic ether group, an aryl group, an aryl ether group, a heterocyclic group, a sulfonyl group, a carbonyl group, an ester group, a carbonate group, or the like. Adjacent substituents may also be part of a fused ring. R can be, for example, a substituent that forms a urethane, amide or a thioamide bond with the leuco dye, and can have sufficient heat stability to sustain the manufacturing process (e.g., an extrusion and molding process). Non-limiting examples of substituents include acyl groups ester groups and thioester groups (e.g., —CO-M, where M represents an organic substituent such as an alkyl, aryl, an alkoxy, an aryloxy, or a sulfonyl substituent), and so forth. In one embodiment, R is a benzoyl group. Formula II represents benzoyl leuco methylene blue (BLMB) a blocked leuco dye that is gamma radiation sensitive (i.e., deblocked) during gamma irradiation. Nevertheless, any non-toxic color changing polymers known to those skilled in the art may be utilized to produce the current invention. Alternatively, the current invention may be produced in various permanent transparent colors.

In a further embodiment, the current invention maybe produced with an organic insoluble polymer known to those skilled in the art such as but not limited to high density polyethylene, HDPE.

In one embodiment, the pipet is constructed by: firstly, plastic tube with specification of our pipet body 5 is made with proper plastic material; secondly, under certain temperature, one end 10 of the tube is melted and stretched into thinner tube with the specification of pipet stem 1.

Based on our pipet particular requirement, under a constant well-controlled temperature environment, injection,extrusion and stretching molding are performed to get the final product.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

I claim:

1. A safer polymer Pasteur pipet comprising:
a. a straight end 10;
b. a tubular body 5; and
c. an elongated tapered stem 1, whereas said stem 1 is a maximum length of 10 inches.

2. A safer polymer Pasteur pipet comprising:
a. a tapered end 10;
b. a tubular body 5; and
c. an elongated tapered stem 1, whereas said stem 1 is a maximum length of 10 inches.

3. An apparatus as in claim 1 whereas said pipet is composed of an organically insoluble polymer.

4. An apparatus as in claim 1 whereas said pipet is composed of a color changing material.

5. A safer polymer pipet comprising:
a. a tapered end 10;
b. a tubular body 5; and
c. an elongated tapered stem 1, whereas said entire length is substantially 22.8 cm.

6. A safer polymer pipet comprising:
a. a tapered end 10;
b. a tubular body 5; and
c. an elongated tapered stem 1, whereas said stem 1 tapers to a elongated portion of a consistent diameter.

7. A safer polymer Pasteur pipet comprising:
a. a tapered end 10;
b. a tubular body 5; and
c. an elongated tapered stem 1, whereas said stem 1 is at least as long as one third the length of the body 5 to the tapered end 10.

8. A safer polymer Pasteur pipet comprising:
a. a tapered end 10;
b. a tubular body 5; and
c. an elongated tapered stem 1, whereas said stem 1 is at least as long as the length of the body 5 to the tapered end 10.

9. A safer polymer Pasteur pipet comprising:
a. a rounded end 10;
b. a tubular body 5; and
c. an elongated tapered stem 1, whereas said stem 1 is a maximum length of 10 inches.
